(19) United States
(12) Patent Application Publication
(10) Pub. No.: US 2021/0108856 A1
(43) Pub. Date: Apr. 15, 2021

(54) SYSTEMS AND METHODS FOR REDUCING ARCING IN VACUUM OR PARTIAL VACUUM FURNACE USING DC POWER

(71) Applicant: Desktop Metal, Inc., Burlington, MA (US)

(72) Inventors: Richard Remo Fontana, Cape Elizabeth, ME (US); Leon Fay, Lexington, MA (US)

(73) Assignee: Desktop Metal, Inc., Burlington, MA (US)

(21) Appl. No.: 17/067,974

(22) Filed: Oct. 12, 2020

Related U.S. Application Data
(60) Provisional application No. 62/913,426, filed on Oct. 10, 2019.
(60) Provisional application No. 62/915,714, filed on Oct. 16, 2019.

(51) Int. Cl. F27B 5/04; B22F 3/00; B33Y 30/00; F27B 5/14; F27D 7/06; F27D 11/04; F27B 5/18

(52) U.S. Cl. CPC F27B 5/04; B22F 3/003; B33Y 30/00; F27D 2019/0003; F27D 7/06; F27D 11/04; F27B 5/18; F27B 5/14

(57) ABSTRACT

A sintering furnace may include a furnace chamber and a retort located within the furnace chamber that receives a part to be heated. The furnace may also include one or more heating elements positioned around the retort and a power controller including power modules connected in series. The power modules may be operably connected to the one or more heating elements and may provide a direct current (DC) power output. A controller may selectively control the power modules to supply power to the one or more heating elements.

### TECHNICAL FIELD

Various aspects of the present disclosure relate generally to systems and methods for of controlling power supply in a furnace, e.g., a sintering furnace for fabricating components.

### BACKGROUND OF THE DISCLOSURE

Metal injection molding (MIM) is a metalworking process useful in creating a variety of metal objects. A mixture of powdered metal and one or more binders may form a “feedstock” capable of being molded, when heated, into the shape of a desired object. The initial molded part, also referred to as a “green part,” may then undergo a preliminary debinding process (e.g., chemical debinding or thermal debinding) to remove primary binder while leaving secondary binder intact, followed by a sintering process. During sintering, the part may be heated to vaporize and remove the secondary binder (thermal debinding) and brought to a temperature near the melting point of the powdered metal, which may cause the metal powder to densify into a solid mass, thereby producing the desired metal object.

Additive manufacturing, which includes three-dimensional (3D) printing, includes a variety of techniques for manufacturing a three-dimensional object via a process of forming successive layers of the object. Three-dimensional printers may in some embodiments utilize a feedstock comparable to that used in MIM, thereby creating a green part without the need for a mold. The printed green part may then be placed in a furnace to undergo debinding and sintering processes to produce the object. Embodiments of the present disclosure focus on aspects of the furnace.

Electrical high-temperature sintering and/or metal processing furnaces are typically controlled by varying the power supplied to resistive heating elements in order to achieve controllable temperature profiles over any given operation cycle. Phase angle firing (also referred to as phase angle switching) is one way to vary power to the heating elements. In phase angle firing, electrically-controllable switches (e.g. semiconductor controlled rectifiers (SCRs)) can be used to rapidly switch power on and off so that the average power is supplied based on the fraction of each sinusoidal cycle during which the switches are activated. For example, an AC power signal at 50/60 Hz (e.g., from an AC mains line) may be “chopped” to control the peak voltage. Although effective at adjusting the power, phase angle switching may create high-frequency transient voltages, may reduce the power factor, and may require large external filters to compensate.

Because of Paschen's Law, at least in the case of vacuum and partial-vacuum atmosphere-controlled furnaces, the transients due to phase angle firing may exacerbate arcing and plasma effects inside the furnace, e.g., at the element electrical contacts and other areas of the element assembly that are in close proximity to a voltage potential. This may cause a variety of degradations that lead to short circuits or immediate failure. Even in the absence of transients, the use of common main AC power (e.g., 400-440 V AC) may cause plasma effects due to the vacuum or partial-vacuum environment inside the furnace chamber due to the higher voltages required with AC power. While step-down transformers can be used to lower voltage, such transformers may be large and expensive.

Alternatively, fixed transformers and adjustable autotransformers may be used to generate controllable AC power. However, fixed transformers may be unsuitable for furnace control because they are not controllably adjustable to vary power output. Further, variable transformers, such as autotransformers, are not generally employed in furnace systems because they require expensive servo mechanical controls.

Lastly, a design based on mains power may not be easily used in different countries that use different voltages. Not only would the power control and supply systems have to be modified to suit localized installations, but the heating elements would require localization as well.

The systems and methods of the current disclosure may address some of the deficiencies described above or may address other aspects of the prior art.

### SUMMARY OF THE DISCLOSURE

Examples of the present disclosure relate to, among other things, systems and methods for fabricating components using additive manufacturing, including furnaces for sintering or debinding such components, or for sintering or debinding components manufactured using traditional methods. Each of the examples disclosed herein may include one or more of the features described in connection with any of the other disclosed examples.

According to an aspect of the disclosure, a sintering furnace may include a furnace chamber, a retort located within the furnace chamber, wherein the retort is configured to receive a part to be heated, one or more heating elements positioned around the retort, a power controller including a plurality of power modules connected in series, wherein the plurality of power modules are operably connected to the one or more heating elements, and wherein each of the power modules is configured to provide a direct current (DC) power output, and a controller configured to selectively control one or more of the plurality of power modules to supply power to the one or more heating elements.

The furnace may include a plurality of heating elements, wherein the plurality of heating elements may be arranged in parallel.

The one or more of the plurality of power modules may be selectively controlled based on one or more of a pressure of the furnace chamber or a temperature of the furnace chamber.

The furnace may further include at least one of a pressure sensor or a temperature sensor.

Each of the plurality of power modules may be configured to convert an alternating current (AC) power input into the DC power output.

Each of the plurality of power modules may include a switching block configured to receive the AC power input, a rectifier block configured to output the DC power output, and a transformer connecting the switching block to the rectifier block.

The one or more heating elements may include at least one of an SiC material or a graphite material.

The furnace may include a plurality of heating elements, wherein a first power module of the plurality of power modules may be configured to provide power to a first heating element of the plurality of heating elements, and wherein a second power module of the plurality of power modules may be configured to provide power to a second heating element of the plurality of heating elements.

According to another aspect, a furnace may include a furnace chamber, a retort located within the furnace chamber, wherein the retort is configured to receive a part to be heated, a plurality of heating elements arranged in parallel around the retort, a power controller including a plurality of power modules connected in series and a plurality of contactors configured to control an output of the plurality of power modules, wherein the plurality of power modules are operably connected to the plurality of heating elements and wherein each of the plurality of power modules is configured to provide a direct current (DC) power output, and a controller configured to selectively control the contactors to supply power to a first set of the plurality of heating elements or a second set of the plurality of heating elements.

The furnace may be configured to operate at a first mode when the first set of the plurality of heating elements is powered, and wherein the furnace may be configured to operate at a second mode when the second set of the plurality of heating elements is powered, wherein more power modules of the plurality of power modules supply power to the plurality of heating elements in the second mode than in the first mode.

At least one of the plurality of power modules may be operably coupled to one or more elements of the furnace other than the plurality of heating elements to supply DC power output to the one or more elements.

A first of the plurality of power modules may be configured to provide a variable output voltage, and wherein a second of the plurality of power modules may be configured to provide a fixed output voltage.

The plurality of heating elements may have a serpentine shape.

According to yet another aspect, a sintering furnace may include a furnace chamber configured to receive a part to be heated, one or more heating elements positioned within the furnace chamber to heat an interior region of the furnace chamber, a power controller including a plurality of power modules, wherein the plurality of power modules are operably connected to the one or more heating elements, and wherein each of the power modules is configured to provide a direct current (DC) power output, and a controller configured to selectively control one or more of the plurality of power modules based on a measured state of the furnace chamber.

The one or more heating elements may include at least one of an SiC material or a graphite material.

The plurality of power modules may be connected in series.

The furnace may further include at least one of a pressure sensor or a temperature sensor configured to measure the state of the furnace chamber.

Each of the heating elements may be a resistive heating element.

Each of the plurality of power modules may be configured to convert an alternating current (AC) power input into the DC power output.

Each of the plurality of power modules may include a switching block configured to receive the AC power input, a rectifier block configured to output the DC power output, and a transformer connecting the switching block to the rectifier block.

Both the foregoing general description and the following detailed description are exemplary and explanatory only and are not restrictive of the features, as claimed. As used herein, the terms “comprises,” “comprising,” “including,” “having,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Additionally, the term “exemplary” is used herein in the sense of “example,” rather than “ideal.” References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth. The terms “object,” “part,” and “component,” as used herein, are intended to encompass any object fabricated through the additive manufacturing techniques described herein.

It should be noted that all numeric values disclosed or claimed herein (including all disclosed values, limits, and ranges) may have a variation of +/−10% (unless a different variation is specified) from the disclosed numeric value. In this disclosure, unless stated otherwise, relative terms, such as, for example, “about,” “substantially,” and “approximately” are used to indicate a possible variation of +/−10% in the stated value. Moreover, in the claims, values, limits, and/or ranges of various claimed elements and/or features means the stated value, limit, and/or range +/−10%.

### BRIEF DESCRIPTION OF THE DRAWINGS

The accompanying drawings, which are incorporated in and constitute a part of this specification, illustrate various exemplary embodiments, and together with the description, serve to explain the principles of the disclosed embodiments. There are many aspects and embodiments described herein. Those of ordinary skill in the art will readily recognize that the features of a particular aspect or embodiment may be used in conjunction with the features of any or all of the other aspects or embodiments described in this disclosure.

FIG. 1A is a block diagram of an additive manufacturing system according to some embodiments of the disclosure.

FIG. 1B illustrates an exemplary printing subsystem of the system of FIG. 1A.

FIG. 1C illustrates an exemplary debinding subsystem of the system of FIG. 1A.

FIG. 1D illustrates an exemplary furnace subsystem of the system of FIG. 1A.

FIG. 2 illustrates an example of another furnace subsystem of the system of FIG. 1A.

FIG. 3 illustrates a power module according to an example.

FIG. 4 illustrates a power controller including the power module of FIG. 3.

FIG. 5 is a timing diagram of a temperature profile of a furnace subsystem according to an example.

FIG. 6 is a plot of a resistivity of a heating element according to a temperature of the heating element according to an example.

FIG. 7A illustrates a retort according to an example.

FIG. 7B illustrates heating elements for use with the retort of FIG. 7A.

FIG. 8 illustrates a power controller for controlling a heating element according to another example.

FIG. 9 illustrates a power controller for controlling a heating element according to yet another example.

### DETAILED DESCRIPTION

Embodiments of the present disclosure include systems and methods to facilitate or improve the efficacy or efficiency of furnaces, for example, a debinding and sintering furnace, which may be part of a larger additive manufacturing system, as described below. Alternatively, however, furnaces of the present disclosure may also be used to process components formed by traditional manufacturing methods, or additive manufacturing methods other than the three-dimensional printing described in the example below. Reference now will be made in detail to examples of the present disclosure described above and illustrated in the accompanying drawings. Wherever possible, the same reference numbers will be used throughout the drawings to refer to the same or like parts.

Vacuum and partial-vacuum furnaces may be beneficial for use as sintering furnaces, particularly sintering furnaces that will be used in an office environment, because they require less voltage to operate. For example, the furnace insulation may work better at vacuum pressures, making the furnace more efficient, and thus reducing the amount of voltage needed to operate the furnace. The reduced voltage requirements may enable use of lower-voltage, three-phase connections, which may be more office friendly. Vacuum furnaces also require the use of less sweep gas or process gas to inhibit the absorption of contaminants by the parts being sintered, which may reduce overall operating costs. As discussed above, however, because of Paschen's law, the use of vacuum and partial-vacuum furnaces may create a higher risk of arcing, and so it may be desirable to even further reduce the voltage requirements of vacuum and partial-vacuum furnaces. In order to further lower the operating voltage requirements, DC power may be used. Accordingly, embodiments of the present disclosure may be drawn to furnace systems configured to facilitate the use of DC power in order to reduce the amount of voltage required for operation in order to reduce arcing. Aspects of the disclosure may be drawn to, e.g., various arrangements of power modules designed for use with DC power. Because AC power is avoided, the use of bulky and expensive transformers to scale down AC voltage may be lessened or avoided. Exemplary embodiments will be described in detail below, although other optional systems and methods for addressing this and similar problems are described in U.S. patent application Ser. No. 16/577,392, filed Sep. 20, 2019, herein incorporated by reference in its entirety.

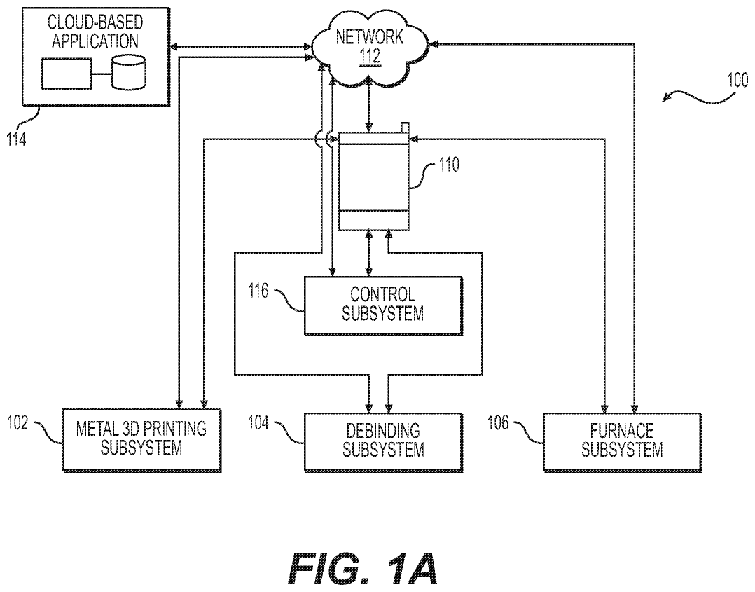

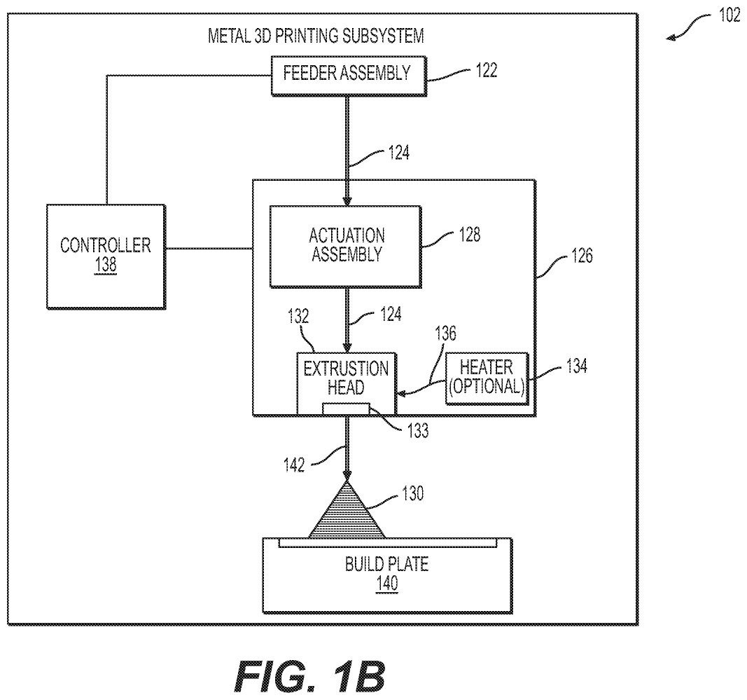

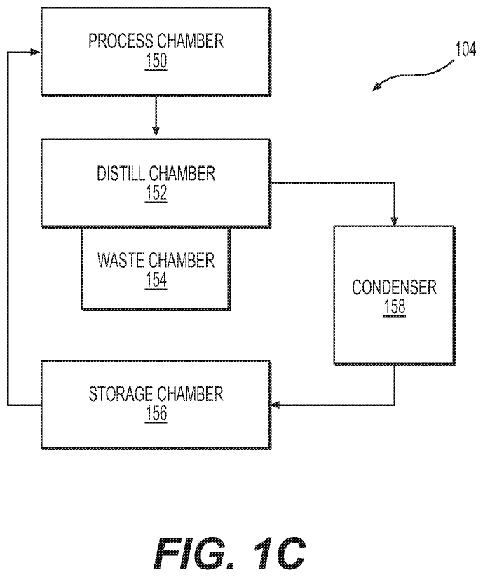

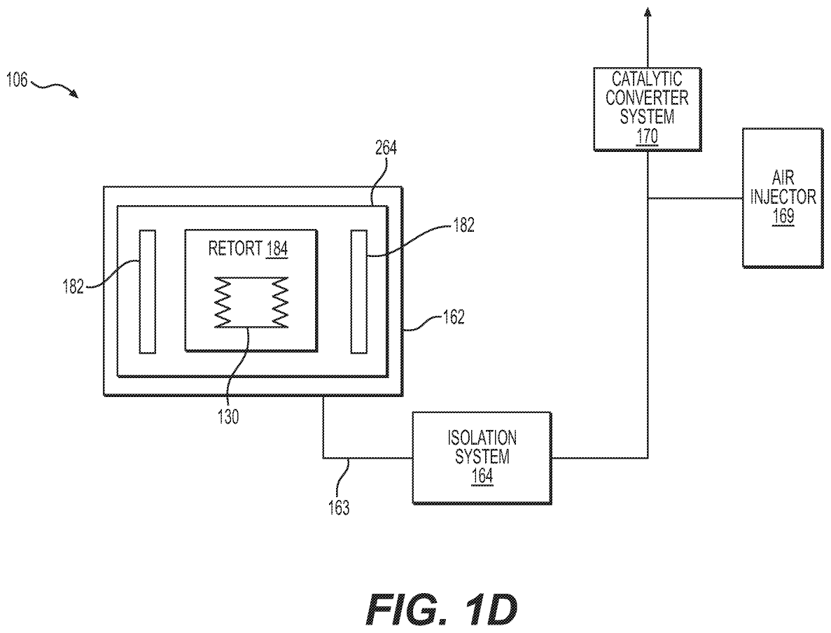

FIG. 1A illustrates an exemplary system 100 for forming a printed object, according to an embodiment of the present disclosure. System 100 may include a three-dimensional (3D) printer, for example, a metal 3D printing subsystem 102, and one or more treatment site(s), for example, a debinding subsystem 104 and a furnace subsystem 106, for treating the green part after printing. Metal 3D printing subsystem 102 may be used to form an object from a build material, for example, by depositing successive layers of the build material onto a build plate. The build material may include metal powder and at least one binder material. In some embodiments, the build material may include a primary binder material (e.g., a wax) and a secondary binder material (e.g., a polymer such as polypropylene).

Debinding subsystem 104 may be configured to treat the printed object by performing a first debinding process, in which the primary binder material may be removed. In some embodiments, the first debinding process may be a chemical debinding process, as will be described in further detail with reference to FIG. 1C. In such embodiments, the primary binder material may dissolve in a debinding fluid while the secondary binder material remains, holding the metal particles in place in their printed form.

In other embodiments, the first debinding process may comprise a thermal debinding process. In such embodiments, the primary binder material may have a vaporization temperature lower than that of the secondary binder material. The debinding subsystem 104 may be configured to heat the deposited build material to a temperature at or above the vaporization temperature of the primary binder material and below the vaporization temperature of the secondary binder material such that the primary binder material is removed from the printed part. In alternative embodiments, the furnace subsystem 106, rather than a separate heating debinding subsystem 104, may be configured to perform the first debinding process. For example, the furnace subsystem 106 may be configured to heat the deposited build material to a temperature at or above the vaporization temperature of the primary binder material and below the vaporization temperature of the secondary binder material such that the primary binder material is removed from the deposited build material.

After debinding subsystem 104 performs the first debinding process, furnace subsystem 106 may be configured to treat the printed object by performing a secondary thermal debinding process, in which the secondary binder material and/or any remaining primary binder material may be vaporized and removed from the printed part. In some embodiments, the secondary debinding process may comprise a thermal debinding process, in which the furnace subsystem 106 may be configured to heat the part to a temperature at or above the vaporization temperature of the secondary binder material to remove the secondary binder material. The furnace subsystem 106 may then heat the part to a temperature just below the melting point of the metal powder to sinter the metal powder and to densify the metal powder into a solid metal part.

As shown in FIG. 1A, system 100 may also include a user interface 110, which may be operatively coupled to one or more components, for example, to metal 3D printing subsystem 102, debinding subsystem 104, and furnace subsystem 106, etc. In some embodiments, user interface 110 may be a remote device (e.g., a computer, a tablet, a smartphone, a laptop, etc.) or an interface incorporated into system 100, e.g., on one or more of the components. User interface 110 may be wired or wirelessly connected to one or more of metal 3D printing subsystem 102, debinding subsystem 104, and/or furnace subsystem 106. System 100 may also include a control subsystem 116, which may be included in user interface 110, or may be a separate element.

Metal 3D printing subsystem 102, debinding subsystem 104, furnace subsystem 106, user interface 110, and/or control subsystem 116 may each be connected to the other components of system 100 directly or via a network 112. Network 112 may include the Internet and may provide communication through one or more computers, servers, and/or handheld mobile devices, including the various components of system 100. For example, network 112 may provide a data transfer connection between the various components, permitting transfer of data including, e.g., part geometries, printing material, one or more support and/or support interface details, printing instructions, binder materials, heating and/or sintering times and temperatures, etc., for one or more parts or one or more parts to be printed.

Moreover, network 112 may be connected to a cloud-based application 114, which may also provide a data transfer connection between the various components and cloud-based application 114 in order to provide a data transfer connection, as discussed above. Cloud-based application 114 may be accessed by a user in a web browser, and may include various instructions, applications, algorithms, methods of operation, preferences, historical data, etc., for forming the part or object to be printed based on the various user-input details. Alternatively or additionally, the various instructions, applications, algorithms, methods of operation, preferences, historical data, etc., may be stored locally on a local server (not shown) or in a storage and/or processing device within or operably coupled to one or more of metal 3D printing subsystem 102, debinding subsystem 104, sintering furnace subsystem 106, user interface 110, and/or control subsystem 116. In this aspect, metal 3D printing subsystem 102, debinding subsystem 104, furnace subsystem 106, user interface 110, and/or control subsystem 116 may be disconnected from the Internet and/or other networks, which may increase security protections for the components of system 100. In either aspect, an additional controller (not shown) may be associated with one or more of metal 3D printing subsystem 102, debinding subsystem 104, and furnace subsystem 106, etc., and may be configured to receive instructions to form the printed object and to instruct one or more components of system 100 to form the printed object.

FIG. 1B is a block diagram of a metal 3D printing subsystem 102 according to one embodiment. The metal 3D printing subsystem 102 may extrude build material 124 to form a three-dimensional part. As described above, the build material may include a mixture of metal powder and binder material. For example, the build material may include any combination of metal powder, plastics, wax, ceramics, polymers, among others. In some embodiments, the build material 124 may come in the form of a rod comprising a predetermined composition of metal powder and one or more binder components (e.g., a primary and a secondary binder).

Metal 3D printing subsystem 102 may include an extrusion assembly 126 comprising an extrusion head 132. Metal 3D printing subsystem 102 may include an actuation assembly 128 configured to move the build material 124 into the extrusion head 132. For example, the actuation assembly 128 may be configured to move a rod of build material 124 into the extrusion head 132. In some embodiments, the build material 124 may be continuously provided from the feeder assembly 122 to the actuation assembly 128, which in turn may move the build material 124 into the extrusion head 132. In some embodiments, the actuation assembly 128 may employ a linear actuation to continuously grip or push the build material 124 from the feeder assembly 122 towards the extrusion head 132.

In some embodiments, the metal 3D printing subsystem 102 includes a heater 134 configured to generate heat 136 such that the build material 124 moved into the extrusion head 132 may be heated to a workable state. In some embodiments, the heated build material 124 may be extruded through a nozzle 133 to extrude workable build material 142 onto a build plate 140. It is understood that the heater 134 is an exemplary device for generating heat 136, and that heat 136 may be generated in any suitable way, e.g., via friction of the build material 124 interacting with the extrusion assembly 126, in alternative embodiments. While there is one nozzle 133 shown in FIG. 1B, it is understood that the extrusion assembly 126 may comprise more than one nozzle in other embodiments. In some embodiments, the metal 3D printing subsystem 102 may include another extrusion assembly (not shown in FIG. 1B) configured to extrude a non-sintering ceramic material onto the build plate 140.

In some embodiments, the metal 3D printing subsystem 102 comprises a controller 138. The controller 138 may be configured to position the nozzle 133 along an extrusion path (also referred to as a toolpath) relative to the build plate 140 such that the workable build material is deposited on the build plate 140 to fabricate a three-dimensional printed object 130. The controller 138 may be configured to manage operation of the metal 3D printing subsystem 102 to fabricate the printed object 130 according to a three-dimensional model. In some embodiments, the controller 138 may be remote or local to the metallic printing subsystem 102. The controller 138 may be a centralized or distributed system. In some embodiments, the controller 138 may be configured to control a feeder assembly 122 to dispense the build material 124. In some embodiments, the controller 138 may be configured to control the extrusion assembly 126, e.g., the actuation assembly 128, the heater 134, the extrusion head 132, or the nozzle 133. In some embodiments, the controller 138 may be included in the control subsystem 116.

FIG. 1C depicts a block diagram of a debinder subsystem 104 for debinding a printed object 130 according to one embodiment. The debinder subsystem 104 may include a process chamber 150, into which the printed object 130 may be inserted for a first debinding process. In some embodiments, the first debinding process may be a chemical debinding process. In such embodiments, the debinder subsystem 104 may include a storage chamber 156 to store a volume of debinding fluid, e.g., a solvent, for use in the first debinding process. The storage chamber 156 may comprise a port which may be used to fill, refill, and/or drain the storage chamber 156 with the debinding fluid. In some embodiments, the storage chamber 156 may be removably attached to the debinder subsystem 104. In such embodiments, the storage chamber 156 may be removed and replaced with a replacement storage chamber (not shown in FIG. 1C) to replenish the debinding fluid in the debinding subsystem 104. In some embodiments, the storage chamber 156 may be removed, refilled with debinding fluid, and reattached to the debinding subsystem 104.

The debinding fluid contained in the storage chamber 156 may be directed to the process chamber 150 containing the inserted printed object 130. In some embodiments, the build material that the printed object 130 is formed of may include a primary binder material and a secondary binder material. The printed object 130 in the process chamber 150 may be submerged in the debinding fluid for a predetermined period of time. In such embodiments, the primary binder material may dissolve in the debinding fluid while the secondary binder material stays intact.

In some embodiments, the debinding fluid containing the dissolved primary binder material (hereinafter referred to as “used debinding fluid”) may be directed to a distill chamber 152. For example, after the first debinding process, the process chamber 150 may be drained of the used debinding fluid, and the used debinding fluid may be directed to the distill chamber 152. In some embodiments, the distill chamber 152 may be configured to distill the used debinding fluid. In some embodiments, the debinding subsystem 104 may further include a waste chamber 154 fluidly coupled to the distill chamber 152. In such embodiments, the waste chamber may collect waste accumulated in the distill chamber 152 as a result of the distillation. In some embodiments, the waste chamber 154 may be removably attached to the debinding subsystem 104 such that the waste chamber 154 may be removed and emptied or replaced after one or more distillation cycles. In some embodiments, the debinding subsystem 104 may include a condenser 158 configured to condense vaporized used debinding fluid from the distill chamber 152 and return the debinding fluid back to the storage chamber 156.

FIG. 1D is a block diagram of the furnace subsystem 106 according to exemplary embodiments. The furnace subsystem 106 may include one or more of a furnace chamber 162, an isolation system 164, an air injector 169 (also referred to as an oxygen injector, which may introduce air or oxygen gas into the system), and a catalyst converter system 170.

The furnace chamber 162 may be a sealable and insulated chamber (e.g., with insulation 264) designed to enclose a controlled atmosphere substantially free of oxygen to prevent combustion and to provide improved materials processing. In the context of the current disclosure, a controlled atmosphere refers to an atmosphere being controlled for one or more of temperature, composition, and pressure. The furnace chamber 162 may include one or more heating elements 182 for heating the atmosphere enclosed within the furnace chamber 162. As shown in FIG. 1D, the printed object 130 may be placed in the furnace chamber 162 for thermal processing. e.g., a thermal debinding process or a densifying process. In some embodiments, the furnace chamber 162 may be heated to a suitable temperature as part of the thermal debinding process in order to degrade any binder components included in the printed object 130 and then may be heated to just below a sintering temperature to densify the part. The furnace chamber 162 may include heat-conductive walls (e.g., graphite retort walls) to spread heat generated by the heating elements 182 within the furnace chamber 162, thereby enhancing temperature uniformity in a region where the printed object 130 is located. The furnace chamber 162 may include a retort 184 with walls partially or fully enclosing the region where the printed object 130 is located. In some embodiments, the furnace chamber 162, specifically the retort 184, may include one or more shelves on which the printed object 130 may be placed within the furnace chamber 162.

Gaseous effluent may be released into the atmosphere of the furnace chamber 162 as the printed object 130 is heated during a thermal processing, e.g., during the thermal debinding process. In some embodiments, the gaseous effluent may be pumped out of the furnace chamber 162, flowed through the isolation system 164, and directed towards the catalytic converter system 170. The isolation system 164 may be configured to prevent downstream fluid (e.g., gas, particularly oxygen gas from air injector 169) from flowing back towards the furnace chamber 162. The isolation system 164 or catalytic converter system 170 may be configured to remove at least a portion of the toxic fumes, e.g., at least a portion of the volatilized binder components, from the gaseous effluent.

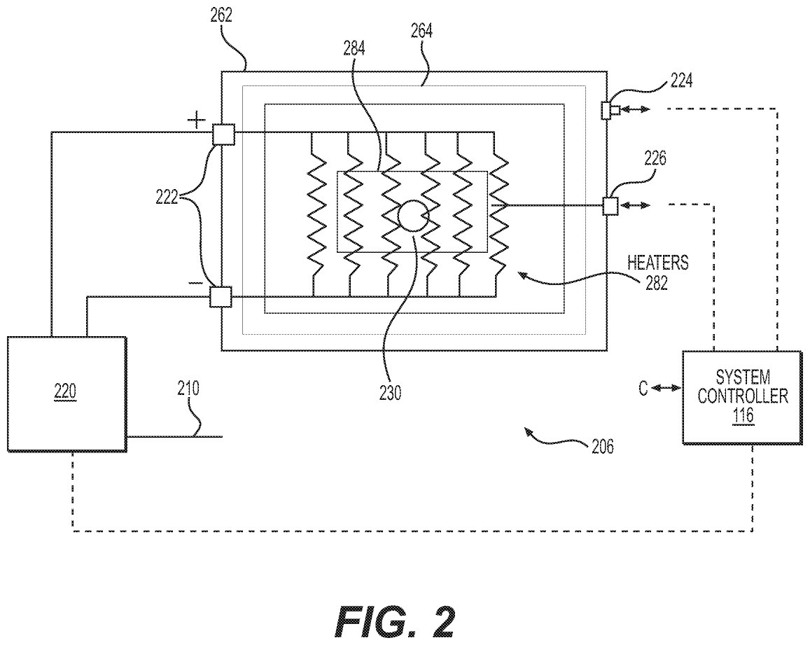

With reference to FIG. 2, a furnace subsystem 206 according to embodiments of the present disclosure is shown. Furnace subsystem 206 may include features similar to those features of furnace subsystem 106 illustrated in FIG. 1D. Unless indicated otherwise, like elements of furnace subsystem 206 may include similar properties as those elements in furnace subsystem 106. Furnace subsystem 206 includes a furnace chamber 262 and a power controller 220, as shown in FIG. 2, but may also include one or more of an isolation system 164, air injector 169, and/or catalytic converter system 170, not shown in FIG. 2.

Furnace chamber 262 of FIG. 2 may include heating elements 282 for heating the atmosphere of furnace chamber 262. For example, a part to be sintered, e.g., a part 230 (or a plurality of printed objects), may be placed in retort 284, which may be partially or completely surrounded by heating elements 282. As will be described herein, heating elements 282 may be arranged in parallel. A parallel arrangement may promote more uniform aging of the heating elements and may allow the resistance of each heating element 282 to be measured. Measurement may occur with serial or parallel arrangements. For example, in a parallel arrangement, more feedthroughs may be added to measure resistances of smaller groups, e.g., measure each individual heating element 282, if desired. Faulty heating elements may accordingly be identified and replaced, potentially preemptively, if they follow a reliable aging curve. That said, heating elements 282 are not limited to the shape and/or configuration shown in FIG. 2.

Heating elements 282 may include resistive SiC heating elements. Alternatively, or additional, heating elements 282 may comprise one single resistive heater element configured as a serpentine structure, e.g., a serpentine graphite element. In this configuration, an approximately ⅛″ thick piece of graphite approximately ¾″ wide may be oriented around the retort 284 in a serpentine arrangement having a total length, e.g., of six feet or greater. It will be understood that the length of heating element 282 may vary according to a size and shape of retort 284.

Furnace chamber 262 may further include insulation 264, e.g., thermal insulation, to thermally insulate the interior of furnace chamber 262 from the ambient atmosphere. Insulation 264 may be, e.g., at least approximately a five- to six-inch-thick alumina fiber board, but may be thinner or thicker depending on desired operating power and temperature requirements. Other insulation materials may be used, such as graphite fiber insulation, alumina/silica insulation, zirconia or stabilized zirconia insulation, refractory metal insulation layers, SiC or SiC coated fiber insulation, ceramic, or any suitable insulation. Insulation may incorporate one or more materials, which may be layered or divided by sealing retorts into regions for control of gas flow or temperature regulation. It will be understood that the thickness and/or material of insulation 264 is not limited thereto, but will be sufficient to maintain a temperature of the interior of furnace chamber 262. For example, furnace subsystem 206 may provide for maximum temperature of approximately 1400 C within furnace chamber 262 under a steady state holding power of approximately 3 KW. However, heating elements 282 and power controller 220 may be configured to provide greater power than 3 KW, as short-term and/or instantaneous power up to 6-7 KW may be utilized during transient operation, particularly for achieving high upward ramp rates in temperature, e.g., during sintering of part 230 within the retort 284. According to an example, insulation 264 may be chosen so that, at an ambient temperature of 25 C, the maximum temperature of the outer surface of the furnace chamber 262 does not exceed approximately 100 C, such that an exterior of the entire furnace subsystem 206 is less than approximately 60 C, or cool enough to touch without burning.

Furnace chamber 262 may further include power feedthroughs 222, one or more pressure sensors 224, and one or more temperature sensors 226, e.g., in a wall thereof. It will be understood that the positioning of power feedthroughs 222, pressure sensors 224, and temperature sensors 226 are not limited to the positioning shown in FIG. 2, and any suitable arrangement or number of components may be used.

Power feedthroughs 222 may include both a positive terminal and a negative terminal and may connect heating elements 282 to respective positive and negative terminals of power controller 220. Power feedthroughs 222 may be any electrical connector that provides suitable electrical connection between power controller 220 and heating elements 282, maintains a suitable atmosphere and temperature within furnace chamber 262, and prevents effluent, e.g., gaseous effluent, from escaping furnace chamber 262 during operation. Such connections may be sealed with gas tight ceramic or glass electrical isolation between conductive components. In some aspects, the feedthroughs may be sealed with copper with aluminum insulation. Such connections may be located at relatively low temperature locations where it may be possible to use elastomeric seals in combination with other materials or alone as electrical insulation. Additionally, it may be desirable to locate the electrical connections in common with other feedthroughs, such as gas feedthroughs. For example, an electrical feedthrough might be concentrically or eccentrically located in a gas feedthrough. This may be advantageous in reducing or minimizing the amount of heat that leaks through the insulation. A common main power line 210 provides power (e.g., 450V or less) to power controller 220.

Pressure sensor 224 may be any suitable sensor for measuring a pressure of the atmosphere within furnace chamber 262, such as a mechanical sensor, an electrical sensor, or the like. Pressure sensor 224 may provide feedback, e.g., pressure feedback, to control subsystem 116. The pressure feedback may cause control subsystem 116 to provide a feedback to a user, such as a visual, an audible, or a haptic feedback, to inform the user of the pressure of furnace chamber 262. Control subsystem 116 may subsequently receive, directly or via a remote system, an input based on the pressure feedback. For example, a user may shut down the system based on the pressure feedback. Alternatively, or additionally, control subsystem 116 may automatically vent an effluent via the isolation system in response to the pressure feedback. Although one pressure sensor 224 is depicted in FIG. 2, it is understood that a plurality of pressure sensors 224 may be included in one or more suitable locations relative to furnace chamber 262.

Temperature sensor 226 may be any suitable sensor for measuring a temperature of the atmosphere within furnace chamber 262, such as a mechanical sensor, an electrical sensor, or the like. As with pressure sensor 224, temperature sensor 226 may provide feedback, e.g., temperature feedback, to control subsystem 116. The temperature feedback may cause control subsystem 116 to provide any control or any alert discussed above with respect to pressure sensor 224. Further, control subsystem 116 may shut down heating elements 282 by cutting power thereto if a temperature of furnace chamber 262 meets or exceeds a maximum threshold temperature. As discussed above, control subsystem 116 may vent the atmosphere therein to achieve an ambient temperature if the temperature within furnace chamber 262 becomes too great. Alternatively, if a temperature of the furnace subsystem 206 is too great, heating elements 282 may be shut off and any valves may be closed to prevent heat and/or gases from escaping furnace subsystem 206, and furnace subsystem 206 may be allowed to cool to an ambient temperature. Although one temperature sensor 226 is depicted in FIG. 2, it is understood that a plurality of temperature sensors 226 may be included in one or more suitable locations relative to furnace chamber 262.

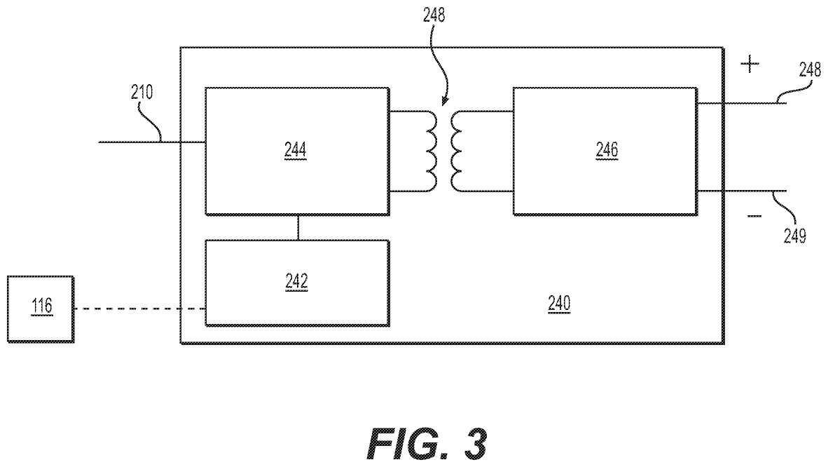

FIG. 3 illustrates a power module 240 for use in, for example, power controller 220. Power module 240 may include a switching/power factor correction (PFC) block 244, which includes circuitry to receive a main power signal, perform power factor correction on the main power signal, and switch on and off a supply output power. A controller 242 may be operatively connected to switching/PFC block 244 to selectively enable supply output power in accordance with an external control signal, e.g., a control from control subsystem 116. A rectifier/filter block 246 may connect to the switching/PFC block 244 via an isolating transformer 248, and may output the supply output power. According to an example, power module 240 may receive power from main power line 210. Since power module 240 may be, e.g., a 24-volt high-current DC switching-type supply having a sufficiently isolated output (via transformer 248) to enable series operation with multiple power modules, power module 240 may switch the power from main power line 210 to the DC switching-type supply. According to an example, power module 240 may allow a maximum power to be achieved at 90 V DC, without substantial arcing at pressures under 100 Torr (e.g., pressures at which furnace systems may be prone to arcing and plasma). Control subsystem 116 may monitor various states of the furnace system 206, such as pressure and temperature of the atmosphere within furnace chamber 262, as described herein. Control subsystem 116 may also control power controller 220 to achieve a desired temperature and pressure within furnace chamber 262, as will be described herein. In this manner, a part may be heated, e.g., sintered, using less gas in furnace chamber 262 during the heating process.

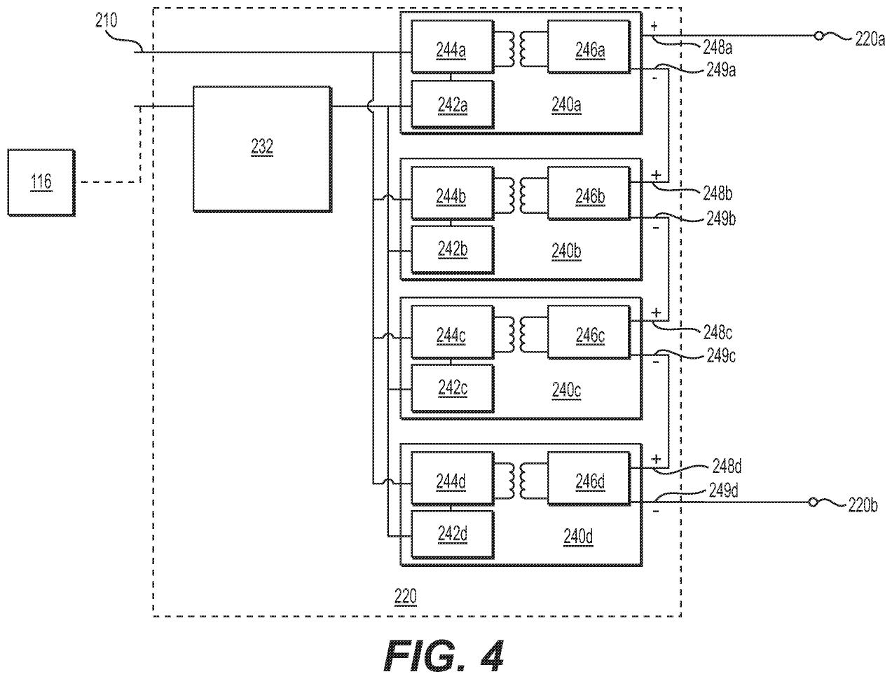

FIG. 4 illustrates power controller 220 having a module controller 232 and a plurality of power modules 240a-240d. Although standard DC voltages may not be ideal for powering heating elements, this may be compensated for by stacking multiple power supplies in series. This may be possible particularly if the supplies are rated for kilovolts of isolation. By stacking a sufficient number of power supplies, furnaces disclosed herein may handle a wider range of heating element resistance and may increase a heating element's useful life by, e.g., software compensation of the DC power supply.

Power modules 240a-240d may include switching/PFC blocks 244a-244d, controllers 242a-242d, and rectifier/filter blocks 246a-246d. While each of power modules 240a-240d illustrated in FIG. 4 includes the same components as power module 240, one or more of power modules 240a-240d may have additional and/or different components from the other power modules 240a-240d. In other words, if multiple power modules 240 are included, each power module may have the same components, or one or more power modules 240 may have different components. Each of switching/PFC blocks 244a-244d may receive power from main power line 210. Further, control subsystem 116 may be operably connected to controllers 242a-242d to control operation of each of power modules 240a-240d.

Power modules 240a-240d are connected in series and may provide power output via a single positive terminal output 220a and a single negative terminal output 220b (although the positions of positive terminal output 220a and negative terminal output 220b may be flipped), which are delivered to respective positive and negative power feedthroughs 222 (shown in FIG. 2). While FIG. 4 only shows four power modules 240a-240d, it will be understood that power controller 220 may include any number of power modules 240 to provide a sufficient power output.

With continued reference to FIG. 4, main power line 210 provides power to power controller 220 and each of power modules 240a-240d. Module controller 232 is connected to controllers 242a-242d of respective power modules 240a-240d. Module controller 232 controls power modules 240a-240d, e.g., an output power level thereof, based on external control signals, e.g., from control subsystem 116, to individually and/or collectively control modules 240a-240d. For example, module controller 232 may receive a control signal corresponding to one or more of a desired temperature of furnace chamber 262 or a desired voltage, current, or power output. Control subsystem 116 may determine the control signal to send to module controller 232 based on a temperature profile or some other control parameter. For a temperature control example, control subsystem 116 may calculate the power necessary to be supplied to heating elements 212 in order to reach or maintain a temperature of furnace chamber 262 indicated by the temperature profile for a given time. Other control parameters may be combined with temperature or used instead of temperature for control. For example, pressure may be used as a control parameter. If the pressure exceeds a target range, the power may be reduced, and if the pressure falls below a target range, the power may be increased. Pressure may also be used to modify the temperature target or desired temperature ramp rate. For example, it may be desirable to limit pressure to below a specific value, e.g., for safety reasons or for process reasons. In some embodiments, chemical content of the furnace may be a control parameter. For example, the presence or absence of a chemical component or gas in the furnace, or effluent stream from the furnace, may indicate initialization or completion of a process and may be used to control the furnace power. Such calculation of desired furnace power may also be made based on the pressure and/or temperature of the furnace chamber 262 as measured, for example, by the pressure sensor 224 and temperature sensor 226. Alternatively, module controller 232 may be omitted, and power controller 220 may issue commands directly to each of power modules 240a-240d to enable and/or disable power modules 240a-240d as required to achieve the desired temperature.

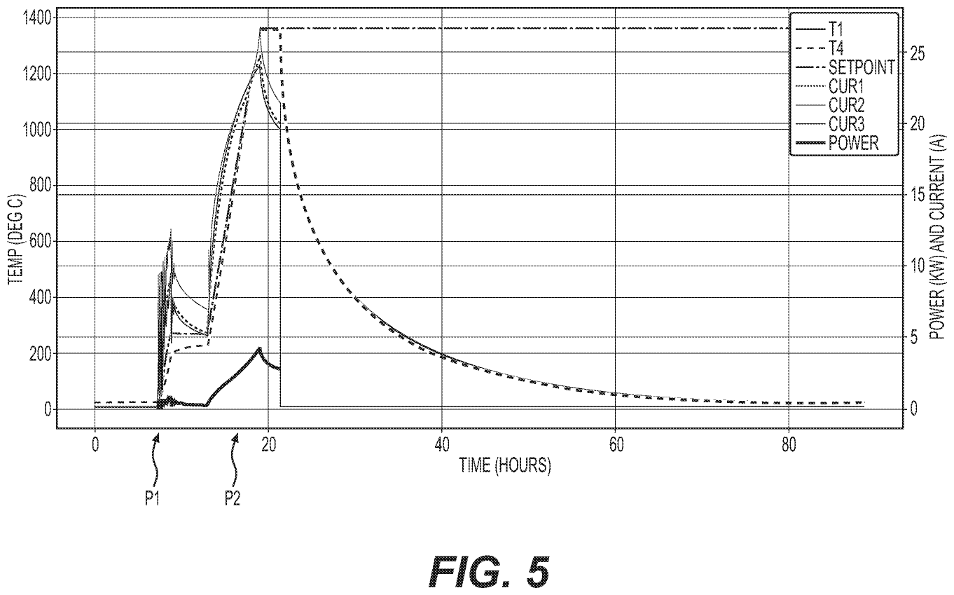

According to an example, control subsystem 116 may control power controller 220 to output power to heating elements 282 (FIG. 2). A timing diagram of the operation of furnace chamber 262 according to an example is illustrated in FIG. 5. As shown in FIG. 5, a temperature of furnace chamber 262 is represented on the y-axis and an elapsed time of a heating operation of furnace chamber 262 is shown along the x-axis. A power and current supplied to heating elements 282 is represented on the right side of the graph, with the lowest line on the graph representing power. It will be understood that this graphical illustration is merely an example of one possible heating operation of furnace chamber 262.

Values associated with the timing diagram, and/or additional values associated with one or more additional characteristics of furnace chamber 262, may be stored as a look-up table (LUT) in a memory associated with, e.g., control subsystem 116. Control subsystem 116 may compare feedback values, e.g., pressure and temperature feedback values received from pressure sensor 224 and temperature sensor 226, respectively, to furnace chamber 262 characteristics stored in the LUT. In response to the comparison, control subsystem 116 may send control signals to module controller 232 to control the power output of one or more of power modules 240a-240d.

With continued reference to FIG. 5, an example for controlling furnace chamber 262 is shown. For example, in one exemplary temperature cycle, during an initial phase (0-7 hours), furnace chamber 262 may maintain a relatively lower temperature while the atmosphere is pumped out of furnace chamber 262 and inerted. During this initial phase, power module 240 may be turned off. At hour 7, (indicated by P1) power module 240 may supply power to heating elements 282 to increase the temperature of furnace chamber 262 to a debind temperature, which may be dependent on the materials being processed, e.g., to a temperature of approximately 250 C to 320 C for a first hold and additional holds from 250 C to 550 C for many iron-based powder metal process binders. Debind temperature depends on the powder material and the binder utilized. For example, debind for silver may range from 220 to 330 C. As an example, debind may occur from approximately 220 C to approximately 550 C, e.g., 400 C. Once the debind temperature is achieved, the debind temperature may be maintained within a threshold range of values, or increased or lowered based on other measurements, such as pressure, for a period of time, and module controller 232 may control power module 240 to decrease power outputs at positive and negative terminals 220a, 220b.

After the debind temperature is held for a period of time, e.g., in FIG. 5, at hour 13 of the procedure, the power may again increase to bring the temperature of furnace chamber 262 to a sintering temperature, at which the part 230 may be sintered. The sintering temperature and profile may also depend on the material being sintered and the environment of the furnace. The sintering temperature is generally dependent on the melting point of the material, and, e.g., for ferrous alloys, the sintering temperature may also may be dependent on the size, shape, effective density, and size distribution of the powder. Sintering temperature for an aluminum alloy may be in the range of approximately 400 C to 650 C, Sterling silver may sinter in the range of approximately 830 C to 840 C. Gold may sinter in the range of approximately 900 C to 1100 C, copper may sinter in the range of approximately 950 C to 1400 C, steel alloys may sinter in the range of approximately 1300 C to 1360 C, and high-temperature alloys may sinter at higher temperatures. As another example, platinum may sinter in the range of approximately 1525 C to 1650 C. Sintering temperature may depend on the material and other characteristics, such as powder size and shape. The examples presented here demonstrate a range with sometimes wide bands and sometimes narrow bands of control. It will be understood that the depicted debind and sintering temperatures and cycle times are only examples, and the temperatures and cycle times may vary according to the material of part 230, the material or amount of binder in part 230, the size, quantity, or arrangement of part(s) 230 in the retort, etc.

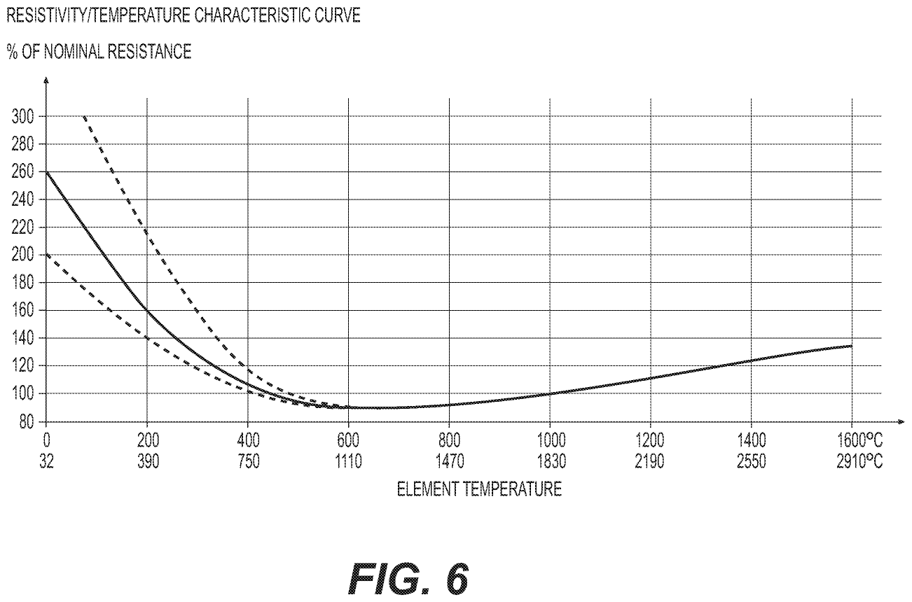

During the sintering phase, the current rise slope may decrease while the power steadily rises at P2. This decrease may occur because, according to an example, heating elements 282 may be formed of SiC, and a resistance of SiC decreases as the temperature of the material reaches approximately 600 C. A resistance of SiC subsequently increases when the material is approximately 700 C. For example, as shown in FIG. 6, the relationship between the resistivity of SiC and the temperature of SiC is illustrated. Since the resistivity of SiC decreases as SiC is heated to approximately 600 C, and the resistivity of SiC again rises as SiC is heated to approximately 700 C, the current and power profiles are achieved as shown at P2 in FIG. 5. By implementing DC power supplies, such as the power modules 240a-240d described herein, examples may allow mode changes from current mode at low voltage conditions (e.g., with low resistances found in other types of heating elements like molybdenum disilicide) to voltage mode at high voltage conditions as necessary.

With reference to FIG. 5, following the sintering phase, e.g., at hour 21 of the procedure, module controller 232 may control power module 240 to be turned off such that power output at positive and negative terminals 220a, 220b is terminated, thereby causing the temperature of furnace chamber 262 to gradually decrease until the atmosphere of furnace chamber 262 achieves an ambient temperature. Upon achieving an ambient temperature, furnace chamber 262 may be opened and accessed by a user to remove the sintered part 230.

In addition to providing high power at low cost, the power modules 240a-240d may also reduce likelihood of plasma and other forms of arcing inside vacuum and partial-vacuum furnaces, such as furnace chamber 262. This may be achieved by operating at lower voltage and by avoiding “chopped” waveforms that have high peaks. To operate at lower voltage, thicker feedthroughs and more current may be utilized to achieve the same or similar power. In some applications, embodiments of the disclosure may enable the use of air-cooled electrical feedthroughs where water-cooled feedthroughs might otherwise be necessary.

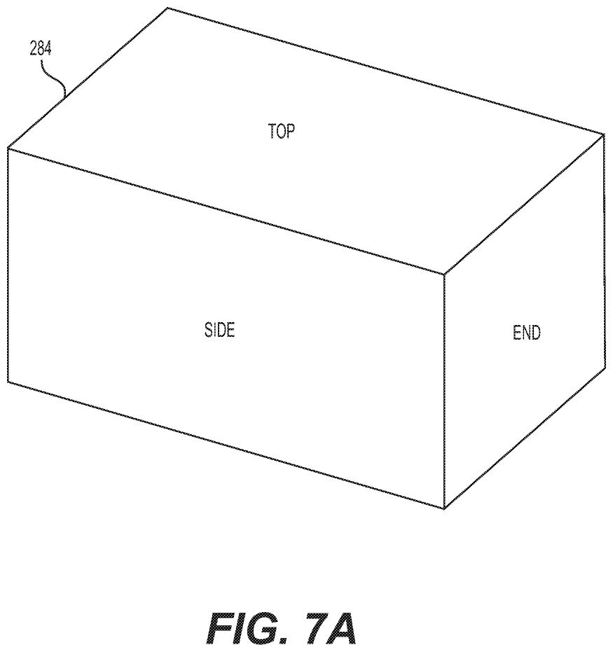

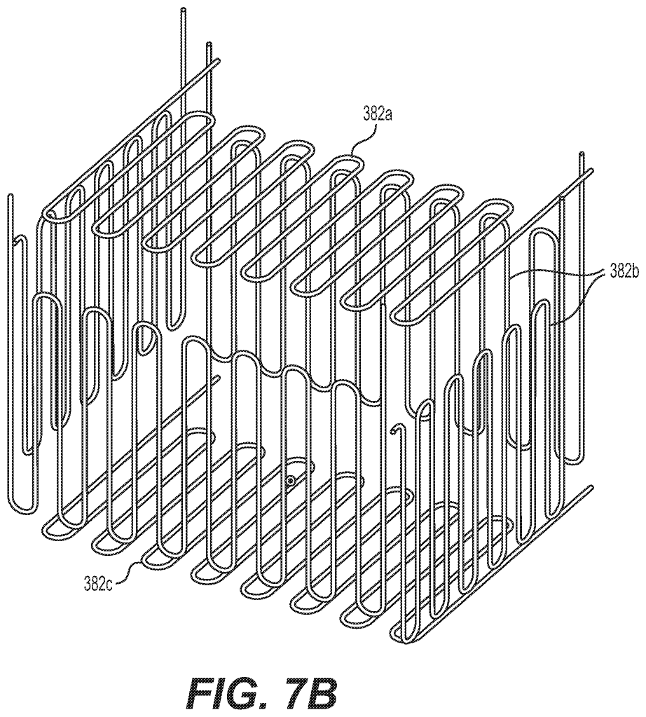

Referring to FIG. 7A, a retort 284 according to another example is shown. Retort 284 includes a top and a bottom (not shown), opposite the top, a first side and a second side (not shown), opposite the first side, and a first end and a second end (not shown), opposite the first end. Retort 284 may occupy, e.g., a cubic or prismatic shape, and may be used to heat any object sized and shaped to fit within retort 284. Retort size may vary widely depending on the furnace size. For example, a very small furnace may have a retort a few centimeters or smaller. A furnace sized for processing several powder metal parts might have a retort of approximately 200 mm×300 mm×200 mm. An industrial furnace retort may be approximately 800 mm×1600 mm×800 mm or approximately 350 mm×250 mm×250 mm. Accordingly, the retort may be any size suitable for carrying out the heating procedure. Additionally, it is possible to use retorts of various sizes in the same furnace or combinations of retorts. The retort may be as large as possible without making contact with the heating elements that typically surround the retort. Additionally, the retort itself may be or may contain the heating element. Additionally, multiple parts 230 may be provided within retort 284, so long as there is sufficient space therein. It will be understood that retort 284 is not limited to the shape shown in FIG. 7A, and may be any shape, e.g., cylindrical, spherical, etc., for heating one or more parts 230.

Reference is now made to FIG. 7B, which illustrates heating elements 382a, 382b, and 382c. While not shown in FIG. 7B for ease of display, retort 284 may be disposed within and surrounded by heating elements 382a, 382b, and 382c (see, e.g., FIG. 2, illustrating heating elements 282 surrounding retort 284). Heating elements 382a, 382b, and 382c may be used to heat different sides of retort 284. For example, heating element 382a may be used to heat a top surface of retort 284, heating element 382b may be used to heat side and end surfaces of retort 284, and heating element 382c may be used to heat a bottom surface of retort 284. As further shown in FIG. 7B, heating elements 382a, 382b, and 382c are serpentine shaped, having parallel sections connected by a curved section. It will be understood, however, that heating elements 382a, 382b, and 382c may be any shape and may be arranged in any manner to sufficiently heat retort 284. Additionally, although heating elements 382a, 382b, and 382c are described, heating elements 382a, 382b, and 382c may in fact be portions of one, long, continuous heating element, or multiple, e.g., two or greater than three, heating elements may be arranged around retort 284 in any suitable configuration.

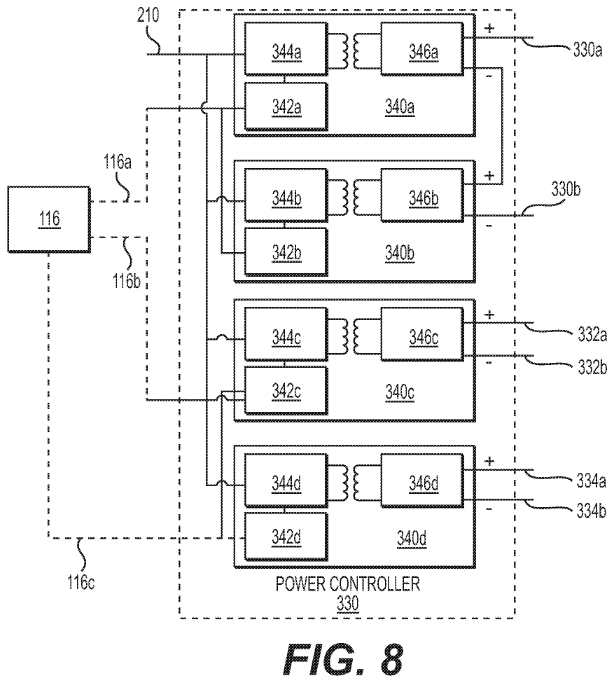

FIG. 8 illustrates another example of a power controller 330. Power controller 330 has similar components as power controller 230, and thus like elements will not be described in detail. For example, power controller 330 may include four power modules 340a-340d, but is not limited to this number and may contain more or fewer. Further, power modules 340a-340d include switching/power factor correction (PFC) blocks 344a-344d, controllers 342a-342d, and rectifier/filter blocks 346a-346d. Each of switching/PFC blocks 344a-344d may receive power from main power line 210. Further, control subsystem 116 may be connected to controllers 342a-342d to control operation of each of power modules 340a-340d.

According to an example, power modules 340a-340d may be combined in series to increase power output for different heating elements. For example, power modules 340a-340b may be combined in series to provide a positive terminal output 330a and a negative terminal output 330b. Positive and negative terminal outputs 330a, 330b may power, e.g., heating element 382b shown in FIG. 7B. A first control signal 116a may be sent from control subsystem 116 to one or both of controllers 342a, 342b to control the power output at positive and negative terminal outputs 330a, 330b. A second control signal 116b may be sent from control subsystem 116 to controller 342c to control positive and negative terminal outputs 332a, 332b. Power from positive and negative terminal outputs 332a, 332b may be used to power, e.g., heating element 382a. A third control signal 116c may be sent from control subsystem 116 to controller 342d to control positive and negative terminal outputs 334a, 3324. Similarly, positive and negative terminal outputs 334a, 334b from power module 340d may be used to power, e.g., heating element 382c. It will be understood that the number of power modules 340 is not limited. It will be further understood that different power modules 340 may be connected in series and/or may be independently controlled to supply power to different heating elements 382a-382c, or different portions of the same heating elements.

Heating elements 382a-382c may be connected in various ways. The optimum configuration may depend on the surface area, heat loading, thermal mass in the region of the heater, and the characteristics of the heater and power supply. As an example, a configuration in which the perimeter of the heating elements, consisting of the sides and ends, may provide an efficient insulation region with low heat loss and radiative coupling through the retort walls to the load. Conversely, the top and bottom surfaces of retort 284 may have penetrations for supports, power feeds, gas feeds, and thermocouples, and the heating elements may be spaced around or shaped to avoid those structures. Additionally, a hearth plate (not shown) and load (e.g., part 230) sitting thereon presents a high thermal mass to the floor and the bottom insulation may see a relatively cold bottom due to convection effects. The top surface of retort 284 may have a lower thermal mass and less loss due to convection. Thus, the ends alone may be too small to match a power supply's capacity and may need to be combined with another surface. For this situation, a perimeter heater with separate top and bottom heaters may be a suitable configuration.

Heating elements 382a-382c may be configured in multiple ways. For example, in the configuration described above, the extra area of the top and bottom ends may be countered by better insulation and lower thermal mass experienced by the perimeter heaters 382b. Each corner set (i.e., one end and side wall) of the perimeter heater 382b may be driven by a power supply; however, the loads may be symmetric. Therefore, one serpentine wire may extend around the perimeter, which may require only two insulation pass-throughs, thereby reducing heat loss. This arrangement may be driven by two power supplies in series, e.g., power modules 340a, 340b. Meanwhile, the heating elements 382a, 382c for heating the top and the bottom of retort 284 may each be driven by their own power supplies, e.g., power modules 340c, 340d, respectively. This configuration may allow surfaces having different boundary conditions, e.g., top, bottom, and perimeter sides of retort 284, to be driven individually to match the required power to achieve the desired local ramp rate/temperature.

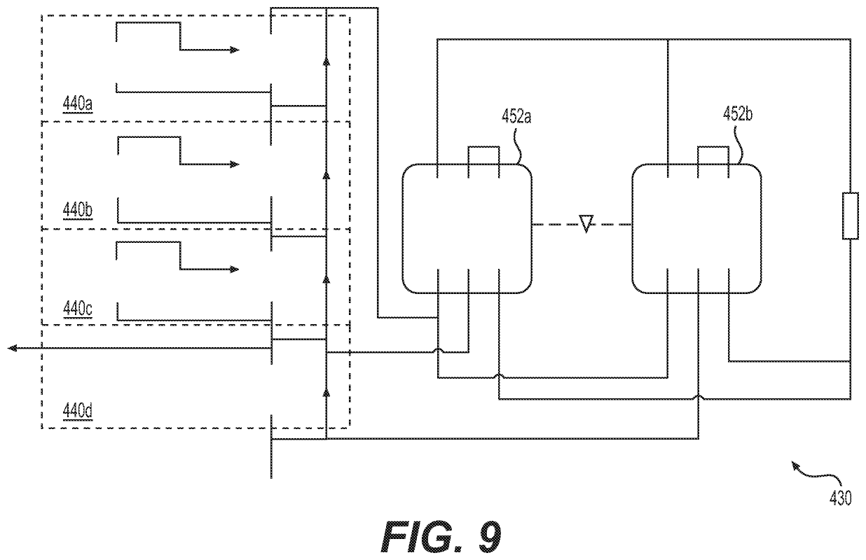

FIG. 9 illustrates a power controller 430 according to another example. Power controller 430 may be implemented in place of the power controller 220 in the furnace subsystem 206 of FIG. 2. As shown in FIG. 9, power controller 430 includes two contactors 452a, 452b configured to selectively couple a subset of power modules 440a-440d to the load, e.g., heating elements 282 in FIG. 2. Control subsystem 116 (not shown in FIG. 9) may control contactors 452a, 442b in a manner similar to that described above with reference to power controller 220 in FIG. 4, e.g., to include all of the functionality of power controllers 220 and 330 described herein. For example, control subsystem 116 may activate one of the contactors 452a, 452b based on a selected mode of operation. For example, for a range of low heater voltages, first contactor 452a may be activated. In this mode, three power modules 440a-440c may provide variable power to the heating elements 282, while the remaining power module 440d, for example, provides power to other portions of the furnace subsystem 206. If a range of higher heater voltages is necessary, second contactor 452b may be activated. In this mode, all four power modules 440a-440d may supply power to the heating elements 282. In this example, power modules 440a-440c may output a variable voltage that is adjustable by control subsystem 116, and power module 440d, for example, may provide a fixed output. In this mode, power module 440d may provide power to heating elements 282 and to other portions of the system. Power modules 440a-440d have similar components as power modules 330a-330d, and are thus not described in detail herein.

Power for power modules described herein may originate from a DC bus, power mains, or a generator. According to an example, DC power supplies may allow easy accommodation of a wide range of input power sources, including three phase, single phase, and DC power over a wide range of voltages. An example of the usefulness of this ability is the example of 208 V three-phase or 240 V single-phase power availability, which is dependent on local and electrical service.

Furnaces may be further adapted for other geometries or sizes of power supplies. In some aspects, the controllable power supply approach described herein may provide greater design freedom, better zone control (e.g., control of heating elements), and better performance than systems that must be phase balanced (e.g., systems supplying AC power directly to heating elements). The supplies can also be reconfigured as conditions or technology changes. For example, a graphite or refractory metal heating element with a very different impedance may be incorporated using the same power supply hardware with minor wiring and control changes.

The example embodiments described above also provide flexibility to match the conditions for any furnace type or operating condition. This is beneficial for furnaces because the area of the top and bottom (or ends for an end opening furnace) are typically not the same as that of the perimeter (or tops and sides for an end opening furnace), and heat loss per area from the top and bottom are not necessarily the same. Further, the thermal mass distribution, which can vary for different use cases, can strongly impact the power distribution required to achieve the desired temperature uniformity (or variation) during ramp. The ability to drive each zone independently may allow more accurate control of ramp rate temperature distribution, even when the heating power requirements are highly uneven and vary in proportion depending on the temperature and ramp rate. This may be particularly interesting advantage of the DC drive for furnace heaters. It is possible to utilize AC to DC heating elements, which may be commonly done in the art. Advantages of DC control as described herein may be reduced peak voltage and current for the same power compared to an AC drive. The reduced voltage of the DC drive may reduce arcing and corona, effects which are initiated and maintained by voltage differences and distances between elements at different voltages in the furnace. The elimination of high transient switching voltages, common in typical AC furnace controllers, is advantageous of DC control, as transients can initiate corona discharge that can then be maintained at lower voltages.

Example power modules of the disclosure may also provide power-based matching. For a balanced heating/insulation system and furnace load, matching the power delivered by each power supply can match the heating and, thus, the temperature of the furnace. Power being delivered by the supply is generally an available measurable quantity. While the resistances of the different heating elements may be different, the heating can be uniform. This may allow for better furnace performance for lower cost with fewer temperature measurements. Heating elements may vary for each furnace, which will change the power necessary to achieve the desired temperature. Matching the delivered power will match the heating without requiring matched heating elements or calibration runs. Indeed, entirely different heating elements and different power supplies may be used as replacements in furnaces. As long as the characteristic heat loads required for proper operation are known, the power required to drive those loads can be delivered accurately with the individual supply approach.

Example power modules of the disclosure may also eliminate the need for individual calibration of furnaces. For multiple zone systems, such as top and bottom as well as side heating, the power supplied to each zone may not be equal, and calibration may be necessary. However, once the required powers for each zone have been determined with an instrumented experimental rig, the furnaces may be matched by matching power. Thus, individual furnaces may not need to be individually calibrated or matched, thereby reducing cost and time.

Example power modules may further provide enhanced diagnostics and operation under partial failure conditions. Impending failure might be detected. If the voltage and current to deliver the required target power depart from the designed range, then an issue with one or more heating elements, e.g., failing, shorting, or arcing/plasma, is likely occurring. The advanced operational modes of switching power supplies may allow a process to go to completion even if a heating zone is failing by compensating power reduction in one area with an increase in another. Alternatively, or additionally, the advanced operational modes may allow the power supply to handle transient shorts without blowing fuses and/or saturating transformers.

Example power modules of the disclosure may further allow for the load behavior to be determined. Controlling and monitoring the power, voltage, and current along with temperature provides a check on the performance of the insulation pack for diagnostics. If the insulation pack state is known, it may also allow determination of whether furnace loading matches expectations. For example, if the ramp rate or temperature distribution is not matching expectations, then there is evidence that the load does not match the predetermined profile and that the profile should be adjusted.

Example power modules of the disclosure may also provide a means of checking the load behavior to control debind. If the power supplied to heating elements does not match the temperature and pressure expectations during debind, there may be a mismatch between the debind profile and the load. Thus the system may be controlled to debind better to reduce cracking.

Example power modules of the disclosure may further provide a potential for feedback control. That is, it may be possible that a measured response to furnace power may allow a control system to perform a cycle matched to the load rather than a prescribed cycle, which might deviate from the expected behavior for numerous reasons.

In some aspects, furnaces of the present embodiment may allow DC supplies to be swapped out or re-arranged to handle voltages of different countries without changing the heating elements. This may allow for more standardization and uniformity even for furnaces that are localized to different countries so that the same or similar results for the same process parameters may be achieved with different furnaces.

While examples have been particularly shown and described, it will be understood by those skilled in the art that various changes in form and details may be made therein without departing from the scope of the embodiments encompassed by the appended claims.

What is claimed is:

1. A furnace for sintering additively manufactured metal parts, the furnace comprising:
a vacuum or partial-vacuum furnace chamber;
a retort located within the furnace chamber, wherein the retort is configured to receive a part to be heated;
one or more heating elements positioned around the retort;
a power controller including a plurality of power modules connected in series or in parallel, wherein the plurality of power modules are operably connected to the one or more heating elements and wherein each of the power modules is configured to provide a direct current (DC) power output; and
a controller configured to selectively control one or more of the plurality of power modules to supply power to the one or more heating elements.

2. The furnace of claim 1, comprising a plurality of heating elements, wherein the plurality of heating elements are arranged in series.

3. The furnace of claim 1, wherein the one or more of the plurality of power modules are selectively controlled based on one or more of a pressure of the furnace chamber and a temperature of the furnace chamber.

4. The furnace of claim 1, further comprising at least one of a pressure sensor and a temperature sensor.

5. The furnace of claim 1, wherein each of the plurality of power modules includes an alternative current (AC) to DC converter configured to convert AC power input into the DC power output, and wherein the furnace operates so as to inhibit arcing.

6. The furnace of claim 5, wherein each of the plurality of power modules includes a switching block configured to receive the AC power input, a rectifier block configured to output the DC power output, and a transformer connecting the switching block to the rectifier block.

7. The furnace of claim 1, wherein the one or more heating elements includes at least one of an SiC material and a graphite material.

8. The furnace of claim 1, comprising a plurality of heating elements, wherein a first power module of the plurality of power modules is configured to provide power to a first heating element of the plurality of heating elements, and wherein a second power module of the plurality of power modules is configured to provide power to a second heating element of the plurality of heating elements.

9. A sintering furnace comprising:
a vacuum or partial-vacuum furnace chamber;
a retort located within the furnace chamber, wherein the retort is configured to receive a part to be heated;
a plurality of heating elements arranged in parallel around the retort;
a power controller including a plurality of power modules connected in series or in parallel, and a plurality of contactors configured to control an output of the plurality of power modules, wherein the plurality of power modules are operably connected to the plurality of heating elements and wherein each of the plurality of power modules is configured to provide a direct current (DC) power output; and
a controller configured to selectively control the contactors to supply power to a first set of the plurality of heating elements or a second set of the plurality of heating elements.

10. The furnace of claim 9, wherein the furnace is configured to operate at a first mode when the first set of the plurality of heating elements is powered, and wherein the furnace is configured to operate at a second mode when the second set of the plurality of heating elements is powered, wherein more power modules of the plurality of power modules supply power to the plurality of heating elements in the second mode than in the first mode.

11. The furnace of claim 9, wherein at least one of the plurality of power modules is operably coupled to one or more elements of the furnace other than the plurality of heating elements to supply DC power output to the one or more elements.

12. The furnace of claim 9, wherein a first of the plurality of power modules is configured to provide a variable output voltage, and wherein a second of the plurality of power modules is configured to provide a fixed output voltage.

13. The furnace of claim 9, wherein the plurality of heating elements have a serpentine shape.

14. A sintering furnace comprising:
a vacuum or partial-vacuum furnace chamber configured to receive a part to be heated;
one or more heating elements positioned within the furnace chamber to heat an interior region of the furnace chamber;
a power controller including a plurality of power modules, wherein the plurality of power modules are operably connected to the one or more heating elements and wherein each of the power modules is configured to provide a direct current (DC) power output; and
a controller configured to selectively control one or more of the plurality of power modules based on a measured state of the furnace chamber.

15. The furnace of claim 14, wherein the one or more heating elements include at least one of an SiC material and a graphite material.

16. The furnace of claim 14, wherein the plurality of power modules are connected in series.

17. The furnace of claim 14, further comprising at least one of a pressure sensor and a temperature sensor configured to measure the state of the furnace chamber.

18. The furnace of claim 14, wherein each of the heating elements is a resistive heating element.

19. The furnace of claim 14, wherein each of the plurality of power modules is configured to convert an alternating current (AC) power input into the DC power output.

20. The furnace of claim 19, wherein each of the plurality of power modules includes a switching block configured to receive the AC power input, a rectifier block configured to output the DC power output, and a transformer connecting the switching block to the rectifier block.
